(19) United States
(12) Patent Application Publication
(10) Pub. No.: US 2019/0270383 A1
(43) Pub. Date: Sep. 5, 2019

(54) REGENERATION CONTROLLER

(71) Applicant: TOYOTA JIDOSHA KABUSHIKI KAISHA, Toyota-shi (JP)

(72) Inventors: Koji Murakami, Toyota-shi (JP); Yuji Matsumura, Toyota-shi (JP); Hiroshi Sato, Nagoya-shi (JP)

(73) Assignee: TOYOTA JIDOSHA KABUSHIKI KAISHA, Toyota-shi (JP)

(21) Appl. No.: 16/273,224

(22) Filed: Feb. 12, 2019

(30) Foreign Application Priority Data
Mar. 5, 2018 (JP) 2018-038685

(51) Int. Cl. B60L 7/18; B60L 7/26; B60K 6/26; B60K 6/28

(52) U.S. Cl. CPC B60L 7/18; B60K 6/28; B60K 6/26; B60L 7/26

(57) ABSTRACT

A regeneration controller that is employed in a hybrid system is configured to control a regenerative braking amount of a motor generator. A hydraulic brake is configured such that a hydraulic braking amount applied to a vehicle is decreased after the depression amount of the brake pedal is decreased by a predetermined first hysteresis amount from the start of a decrease in the depression amount. The regeneration controller is configured to control the motor generator such that, when the depression amount of the brake pedal is decreased, the regenerative braking amount starts decreasing after the depression amount of the brake pedal is decreased by a second hysteresis amount from the start of a decrease in the depression amount. The second hysteresis amount is set to be greater than the first hysteresis amount.

### BACKGROUND

The present invention relates to a regeneration controller that is employed in a hybrid system of a vehicle.

Japanese Laid-Open Patent Publication No. 2013-141339 discloses a hybrid system. The hybrid system is provided with an engine and a motor generator as driving sources of a vehicle. The motor generator is drivably coupled to the engine and functions as a motor by utilizing electricity from a battery, thereby assisting driving of the engine. The motor generator also functions as a generator by utilizing rotational torque of the engine, thereby exerting a regenerative braking force on the vehicle.

In the above-described hybrid system, a regenerative braking amount is set for the motor generator based on the depression amount of the brake pedal, the vehicle speed, and the state of charge of the battery at the time of starting depression of the brake pedal. The regenerative braking amount at this time is restricted to a smaller amount with an increase in the state of charge of the battery at the time of starting the depression of the brake pedal, so that the battery will not be fully charged during execution of regenerative braking.

In the above-described hybrid system, the regenerative braking amount is restricted in accordance with the state of charge of the battery, by which the battery is decreased accordingly in charging speed during execution of the regenerative braking. Consequently, the battery may not be sufficiently charged, unless a relatively long period of time is secured as a period of time during which the regenerative braking is executed, that is, during which the brake pedal is depressed.

### SUMMARY

In accordance with one aspect of the present disclosure, a regeneration controller that is employed in a hybrid system is provided. The hybrid system includes an engine as a driving source of a vehicle, a motor generator that is drivably coupled to the engine, a battery that supplies electricity to the motor generator, a hydraulic brake configured to decelerate the vehicle, and a brake sensor that detects a depression amount of a brake pedal used to operate the hydraulic brake. The regeneration controller is configured to control a regenerative braking amount of the motor generator. The hydraulic brake is configured such that a hydraulic braking amount applied to the vehicle is decreased after the depression amount of the brake pedal is decreased by a predetermined first hysteresis amount from the start of a decrease in the depression amount. The regeneration controller is configured to control the motor generator such that, when the depression amount of the brake pedal is decreased, the regenerative braking amount starts decreasing after the depression amount of the brake pedal is decreased by a second hysteresis amount from the start of a decrease in the depression amount. The second hysteresis amount is set to be greater than the first hysteresis amount.

With the above-described configuration, when the depression amount of the brake pedal starts to decrease, the hydraulic braking amount of the hydraulic brake is first decreased after the depression amount is decreased by a first hysteresis amount. Then, the regenerative braking amount of the motor generator starts to decrease. In other words, even if the hydraulic braking amount of the hydraulic brake starts to decrease and the braking amount on the vehicle starts to decrease in response to operation of the brake pedal, the amount of generated electricity by the motor generator will not be decreased for a certain period of time. As described above, such a period of time during which the amount of generated electricity by the motor generator is not decreased is provided, thus making it possible to efficiently charge the battery even if the period of time during which the brake pedal is depressed is short.

In the above-described aspect, a decreasing process may be executed to gradually decrease the regenerative braking amount of the motor generator with a lapse of time in a period of time during which an absolute value of a change amount of the depression amount of the brake pedal per unit time is less than or equal to a predetermined threshold value.

With the above-described configuration, in a case in which the depression amount of the brake pedal is substantially constant, the electricity supplied from the motor generator to the battery is gradually decreased. Consequently, excessive charging of the battery is prevented. Further, since excessive charging of the battery is prevented, in a case in which the depression amount of the brake pedal is increased again, regenerative braking can be executed by the motor generator, thus making it possible to leave room for charging the battery.

In the above-described aspect, the regeneration controller is configured to execute the decreasing process when conditions are met, one of the conditions being that a state of charge of the battery is higher than or equal to a prescribed charging amount.

In the regeneration controller configured as described above, in a case in which the state of charge of the battery is higher than or equal to a prescribed state of charge, the state of charge of the battery is highly likely to be fully charged upon execution of the regenerative braking by the motor generator. It is preferable that, under these circumstances, the regeneration controller be configured so as to execute a decreasing process for gradually decreasing the regenerative braking amount of the motor generator.

In the above-described aspect, in the decreasing process, after the regenerative braking amount becomes a predetermined lower limit guard value, the regenerative braking amount is set to the lower limit guard value regardless of a lapse of time.

With the above-described configuration, even in a case in which the conditions for executing the decreasing process are satisfied continuously over a long period of time, the regenerative braking amount will not become a value less than the lower limit guard value. Consequently, the regenerative braking amount will not become a significantly small value.

In the above-described aspect, the lower limit guard value is a negative value, and the regeneration controller is configured to cause the motor generator to function as a motor that utilizes electricity of the battery in a case in which the regenerative braking amount has a negative value.

With the above-described configuration, in a case in which the conditions for executing the decreasing process continue over a certain period of time, electricity is supplied from the battery to the motor generator to decrease the state of charge of the battery. Therefore, when the depression amount of the brake pedal is increased again, there is less likelihood of a situation in which the battery is fully charged and the motor generator is unable to execute the regenerative braking.

In the above-described aspect, the regeneration controller is configured to stop the decreasing process and increase the regenerative braking amount in accordance with an increase in the depression amount of the brake pedal in a case in which the depression amount of the brake pedal is increased to exceed the threshold value during the decreasing process.

With the above-described configuration, regardless of whether the decreasing process gradually decreasing the regenerative braking amount Bfin is performed, it is possible to obtain a similar change in deceleration in response to an increase in the depression amount of the brake pedal. Consequently, it is possible to suppress a feeling of uncomfortableness on the part of the driver of the vehicle that the response of the brake pedal varies depending on the presence or absence of execution of the decreasing process.

Other aspects and advantages of the present disclosure will become apparent from the following description, taken in conjunction with the accompanying drawings, illustrating exemplary embodiments.

### BRIEF DESCRIPTION OF THE DRAWINGS

The disclosure may be understood by reference to the following description together with the accompanying drawings:

FIG. 1 is a schematic diagram showing the configuration of a hybrid system of a vehicle;

FIG. 2 is a graph showing a relationship between a brake hydraulic pressure and a regenerative braking amount as well as a relationship between a brake hydraulic pressure and a hydraulic braking amount;

FIG. 3 is a graph showing a relationship between the brake hydraulic pressure and the regenerative braking amount at the time of an increase in the brake hydraulic pressure (first relational expression) as well as a relationship between the brake hydraulic pressure and the regenerative braking amount at the time of a decrease in the brake hydraulic pressure (second relational expression);

FIG. 4 is a diagram illustrating changes in the regenerative braking amount and the hydraulic braking amount at the time of a decrease in the brake hydraulic pressure;

FIG. 5 is a flowchart showing a regenerative control process for the motor generator;

FIG. 6 is a flowchart showing a gradual change process in the course of the regenerative control process;

FIG. 7 is a flowchart showing the gradual change process in the course of the regenerative control process;

FIG. 8 is a graph showing changes in a final regenerative braking amount when the brake hydraulic pressure is changed from constant to increase; and

FIG. 9 is a graph showing changes in the final regenerative braking amount when the brake hydraulic pressure is changed from constant to decrease.

### DETAILED DESCRIPTION

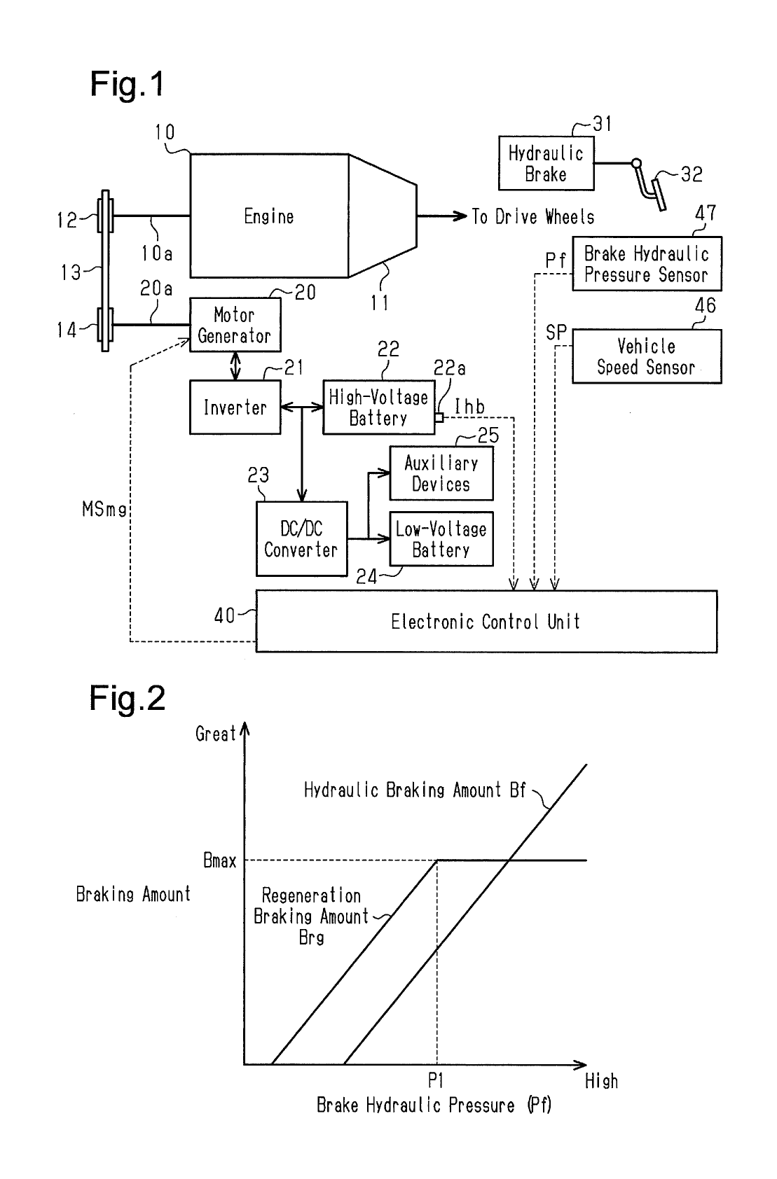

Hereinafter, a description will be given of an embodiment. First, with reference to FIG. 1, a brief description will be given of a configuration of a hybrid system of a vehicle.

As shown in FIG. 1, the hybrid system is provided with an engine 10 as a driving source. A crankshaft 10a of the engine 10 is drivably coupled to drive wheels via a transmission 11. The crankshaft 10a of the engine 10 is also drivably coupled to a first pulley 12. A transfer belt 13 is looped over the first pulley 12. Although not shown in the drawing, the crankshaft 10a of the engine 10 is also drivably coupled to a hydraulic pump configured to generate a hydraulic pressure and a compressor for the air conditioner via belts, pulleys, gears (sprockets), and chains.

The hybrid system is provided with a motor generator 20 as another driving source separately from the above-described engine 10. The motor generator 20 is what-is-called a three-phase alternating current electric motor. An output shaft 20a of the motor generator 20 is drivably coupled to a second pulley 14. A transfer belt 13 is looped over the second pulley 14. That is, the motor generator 20 is drivably coupled to the crankshaft 10a of the engine 10 via the second pulley 14, the transfer belt 13, and the first pulley 12.

The motor generator 20 applies rotational torque to the second pulley 14 when functioning as an electric motor, and the rotational torque is input to the crankshaft 10a of the engine 10 via the transfer belt 13 and the first pulley 12. That is, in this case, the motor generator 20 assists driving of the engine 10. In contrast, when the motor generator 20 functions as a generator, the rotational torque of the crankshaft 10a of the engine 10 is input to the output shaft 20a of the motor generator 20 via the first pulley 12, the transfer belt 13 and the second pulley 14. Then, the motor generator 20 generates electricity in response to rotation of the output shaft 20a. At this time, the motor generator 20 applies a negative rotational torque to the crankshaft 10a, therefore exerting a regenerative braking force on a vehicle.

A high-voltage battery 22 is connected to the motor generator 20 via an inverter 21. The inverter 21 is what-is-called a bidirectional inverter, converting an alternating current voltage generated by the motor generator 20 to a direct current voltage to output it to the high-voltage battery 22 and converting a direct current voltage generated by the high-voltage battery 22 to an alternating current voltage to output it to the motor generator 20. In FIG. 1, the inverter 21 is depicted as being different from the motor generator 20. However, the inverter 21 may be housed inside a casing of the motor generator 20.

The high-voltage battery 22 is a lithium-ion battery. When the motor generator 20 functions as an electric motor, the high-voltage battery 22 supplies electricity to the motor generator 20. Further, when the motor generator 20 functions as a generator, the high-voltage battery 22 is charged by receiving electricity supplied from the motor generator 20.

A sensor portion 22a that detects the state of the high-voltage battery 22 is housed inside the high-voltage battery 22. The sensor portion 22a detects the voltage between terminals, the output current, the temperature, and the like of the high-voltage battery 22 and outputs them as signals that indicate status information Ihb of the high-voltage battery 22.

A DC/DC converter 23 is connected to the motor generator 20 via the inverter 21. The DC/DC converter 23 is also connected to the high-voltage battery 22. The DC/DC converter 23 lowers a direct current voltage output from the inverter 21 or the high-voltage battery 22 down to 12V to 15V and outputs the voltage. A low-voltage battery 24 is connected to the DC/DC converter 23.

The low-voltage battery 24 is a 12V lead-acid battery of which the voltage is lower than that of the high-voltage battery 22. The low-voltage battery 24 outputs a 12V direct current voltage when the DC/DC converter 23 is not activated or the output voltage of the DC/DC converter 23 is 12V. When the output voltage of the DC/DC converter 23 is higher than the open circuit voltage (OCV) of the low-voltage battery 24, the low-voltage battery 24 is charged by receiving electricity supplied from the DC/DC converter 23. Although not shown in the drawing, a sensor portion that detects the voltage between the terminals, the output current, the temperature, and the like of the low-voltage battery 24 is housed inside the low-voltage battery 24.

Various types of auxiliary devices 25 are connected to the DC/DC converter 23 and the low-voltage battery 24. The auxiliary devices 25 include, for example, lights of the vehicle such as the headlights, the turn signals, and the interior light as well as interior devices such as a car navigation system and speakers. The auxiliary devices 25 receive electricity supplied from the low-voltage battery 24 when the DC/DC converter 23 is not activated. When the output voltage of the DC/DC converter 23 is higher than the open circuit voltage (OCV) of the low-voltage battery 24, the auxiliary devices 25 receive electricity supplied from the DC/DC converter 23.

The hybrid system is provided with a hydraulic brake 31 for decelerating the vehicle and a brake pedal 32 used to operate the hydraulic brake 31. The hydraulic brake 31 is connected to a hydraulic pressure circuit and exerts a braking force on the vehicle by a hydraulic braking amount Bf corresponding to a brake hydraulic pressure Pf generated at the hydraulic pressure circuit. Specifically, as shown in FIG. 2, the hydraulic braking amount Bf is zero when the brake hydraulic pressure Pf is significantly low. Then, after the hydraulic braking amount Bf exceeds a certain hydraulic pressure, the hydraulic braking amount Bf becomes greater with an increase in the brake hydraulic pressure Pf. Further, the brake pedal 32 is a foot pedal that is depressed by the driver of the vehicle, and the greater the depression amount of the brake pedal 32, the higher the hydraulic pressure of a master cylinder in the hydraulic pressure circuit becomes.

As shown in FIG. 1, the hybrid system is provided with an electronic control unit 40, which controls the engine 10, the motor generator 20, and the like. The electronic control unit 40 is processing circuitry (computer) that has an arithmetic portion for executing various types of programs (applications), a nonvolatile storage portion for storing programs, and the like, and a volatile memory in which data is temporarily stored in executing programs.

Signals that indicate the states of various sites in the vehicle are input to the electronic control unit 40 from various types of sensors mounted on the vehicle. Specifically, information that indicates a vehicle speed SP is input to the electronic control unit 40 from a vehicle speed sensor 46. A signal that indicates the brake hydraulic pressure Pf is also input to the electronic control unit 40 from a brake hydraulic pressure sensor 47. The brake hydraulic pressure sensor 47 detects the pressure inside the master cylinder at the hydraulic pressure circuit for applying a hydraulic pressure to the hydraulic brake 31 as the brake hydraulic pressure Pf. As described above, the brake hydraulic pressure Pf, which is a pressure inside the master cylinder, is changed in response to the depression amount of the brake pedal 32. Therefore, the brake hydraulic pressure sensor 47 is a brake sensor, which detects the depression amount of the brake pedal 32 via the brake hydraulic pressure Pf.

The status information Ihb is input to the electronic control unit 40 from the sensor portion 22a of the high-voltage battery 22. The electronic control unit 40 calculates the state of charge (SOC) of the high-voltage battery 22 based on information on the voltage between terminals, the output current, the temperature, and the like, of the high-voltage battery 22, which are included in the status information Ihb. In this embodiment, the state of charge of the high-voltage battery 22 is expressed in terms of the ratio of the electric energy charged in the high-voltage battery 22 when the status information Ihb has been input in relation to the electric energy when the high-voltage battery 22 has been fully charged, for example, as a percentage (%).

The electronic control unit 40 generates an operation signal MSmg for controlling the motor generator 20 based on signals input from various types of sensors, and the like, and outputs the operation signal MSmg to the motor generator 20. The motor generator 20 is controlled for the amount of discharged energy when functioning as a motor and for the amount of generated electricity when functioning as a generator based on the operation signal MSmg. As described above, the motor generator 20 exerts a regenerative braking force on the vehicle when generating electricity. Therefore, the electronic control unit 40 functions as a regeneration controller, which controls a regenerative braking amount Brg in the motor generator 20.

The storage portion of the electronic control unit 40 stores a relational expression that is used in calculating the regenerative braking amount Brg. In this relational expression, the regenerative braking amount Brg is determined as a function in relation to the brake hydraulic pressure Pf or the vehicle speed SP. In this embodiment, there are stored a first relational expression, which is used when the brake hydraulic pressure Pf is kept constant or increased (the depression amount of the brake pedal 32 is kept constant or increased), and a second relational expression, which is used when the brake hydraulic pressure Pf is decreased (the depression amount of the brake pedal 32 is decreased).

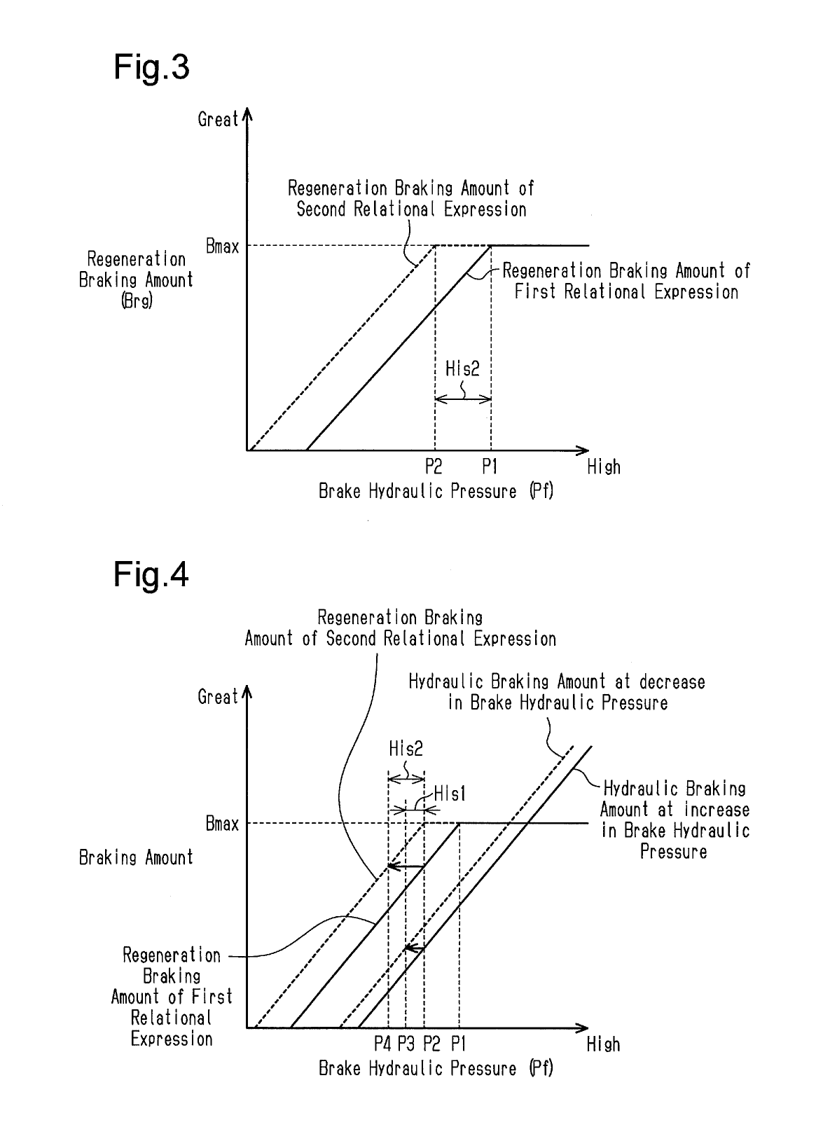

As indicated by a solid line in FIG. 3, on the assumption that the vehicle speed SP is constant, in the first relational expression, the regenerative braking amount Brg is zero when the brake hydraulic pressure Pf is significantly low. Then, after the brake hydraulic pressure Pf exceeds a certain pressure, the higher the brake hydraulic pressure Pf, the higher the regenerative braking amount Brg becomes. When the brake hydraulic pressure Pf is at a predetermined hydraulic pressure P1, the regenerative braking amount Brg reaches a maximum braking amount Bmax. Then, in a case in which the brake hydraulic pressure Pf is higher than the hydraulic pressure P1, the regenerative braking amount Brg is kept constant at the maximum braking amount Bmax. The maximum braking amount Bmax is a braking amount that can be exerted when the motor generator 20 generates (regenerates) an electric power at the maximum rating, or a value determined by a specification of the motor generator 20.

As indicated by a broken line in FIG. 3, on the assumption that the vehicle speed SP is constant, in the second relational expression, as with the first relational expression, when the brake hydraulic pressure Pf is significantly low, the regenerative braking amount Brg is zero. After the brake hydraulic pressure Pf exceeds a certain pressure, the higher the brake hydraulic pressure Pf, the higher the regenerative braking amount Brg becomes. When the brake hydraulic pressure Pf is at a predetermined hydraulic pressure P2, the regenerative braking amount Brg reaches the maximum braking amount Bmax. Then, in a case in which the brake hydraulic pressure Pf is higher than the hydraulic pressure P2, the regenerative braking amount Brg is kept constant at the maximum braking amount Bmax. However, in the second relational expression, at the time when the brake hydraulic pressure Pf is lower than in the case of the first relational expression, the regenerative braking amount Brg starts to increase. Then, in the second relational expression, at the hydraulic pressure P2, which is lower than the hydraulic pressure P1 in the first relational expression, the regenerative braking amount Brg reaches the maximum braking amount Bmax. That is, the regenerative braking amount Brg in the second relational expression is obtained by translating the regenerative braking amount Brg in the first relational expression to the lower side of the brake hydraulic pressure Pf by an amount corresponding to the difference between the hydraulic pressure P1 and the hydraulic pressure P2.

Next, a description will be given of a relationship between the hydraulic braking amount Bf and the regenerative braking amount Brg. The regenerative braking amount Brg in FIG. 2 is determined based on the first relational expression.

As shown in FIG. 2, the regenerative braking amount Brg starts to increase at a lower brake hydraulic pressure Pf than when the hydraulic braking amount Bf starts to increase. Therefore, from the brake hydraulic pressure Pf at which the regenerative braking amount Brg starts to increase to the brake hydraulic pressure Pf at which the hydraulic braking amount Bf starts to increase, the percentage of the regenerative braking amount Brg in relation to the entire braking amount is 100%. Then, from the brake hydraulic pressure Pf at which the hydraulic braking amount Bf starts to increase to the hydraulic pressure P1 at which the regenerative braking amount Brg reaches the maximum braking amount Bmax, the regenerative braking amount Brg and the hydraulic braking amount Bf are both increased with an increase in the brake hydraulic pressure Pf. When the brake hydraulic pressure Pf is higher than the hydraulic pressure Pl, the regenerative braking amount Brg will not be increased to exceed the maximum braking amount Bmax, whereas the hydraulic braking amount Bf will be increased with an increase in brake hydraulic pressure Pf.

In the hydraulic pressure circuit, which supplies a hydraulic pressure to the hydraulic brake 31, loss of the hydraulic pressure occurs when the hydraulic pressure from the master cylinder is transferred to the hydraulic brake 31. Further, a friction loss between individual components also occurs in the hydraulic brake 31 itself. Consequently, in a case in which a change amount from the start of a change of the brake hydraulic pressure sensor 47 is smaller than or equal to a predetermined first hysteresis amount His1, a change in the brake hydraulic pressure Pf is offset by the above-described loss, and the hydraulic braking amount Bf is not changed. Then, in a case in which a change amount from the start of a change of the brake hydraulic pressure sensor 47 exceeds the predetermined first hysteresis amount His1, the hydraulic braking amount Bf is changed. Therefore, as shown in FIG. 4, the hydraulic braking amount Bf (indicated by a broken line in FIG. 4) at the time of a decrease in the brake hydraulic pressure Pf has characteristics in which the hydraulic braking amount Bf (indicated by a solid line in FIG. 4) at the time of an increase in the brake hydraulic pressure Pf is translated to the lower side in the brake hydraulic pressure Pf. The above-described first hysteresis amount His1 is determined by configurations of the hydraulic brake 31 and the hydraulic pressure circuit and the type of the brake fluid filling the hydraulic pressure circuit and can be calculated by conducting tests or simulations in advance. Then, when the difference between the hydraulic pressure P1 at which the regenerative braking amount Brg reaches the maximum braking amount Bmax in the above-described first relational expression and the hydraulic pressure P2 at which the regenerative braking amount Brg reaches the maximum braking amount Bmax in the second relational expression is set to a second hysteresis amount His2, the first relational expression and the second relational expression are determined in advance so that the second hysteresis amount His2 will be greater than the first hysteresis amount His1.

Next, a description will be given of the regenerative control process executed by the electronic control unit 40. The following regenerative control process is executed repeatedly for every predetermined control cycle in a state in which a main switch (which is also from time to time referred to as a system activation switch or an ignition switch) of the vehicle is switched on to activate the hybrid system. At the time when the main switch of the vehicle is switched on (at the time when even one cycle of the regenerative control process is not yet completed), the initial value of the brake hydraulic pressure Pf is set to the value of the brake hydraulic pressure Pf when the depression amount of the brake pedal 32 is zero. Further, it is assumed that the initial value of the regenerative braking amount Brg is set to zero. Still further, the initial value of a gradual change flag to be described below is off.

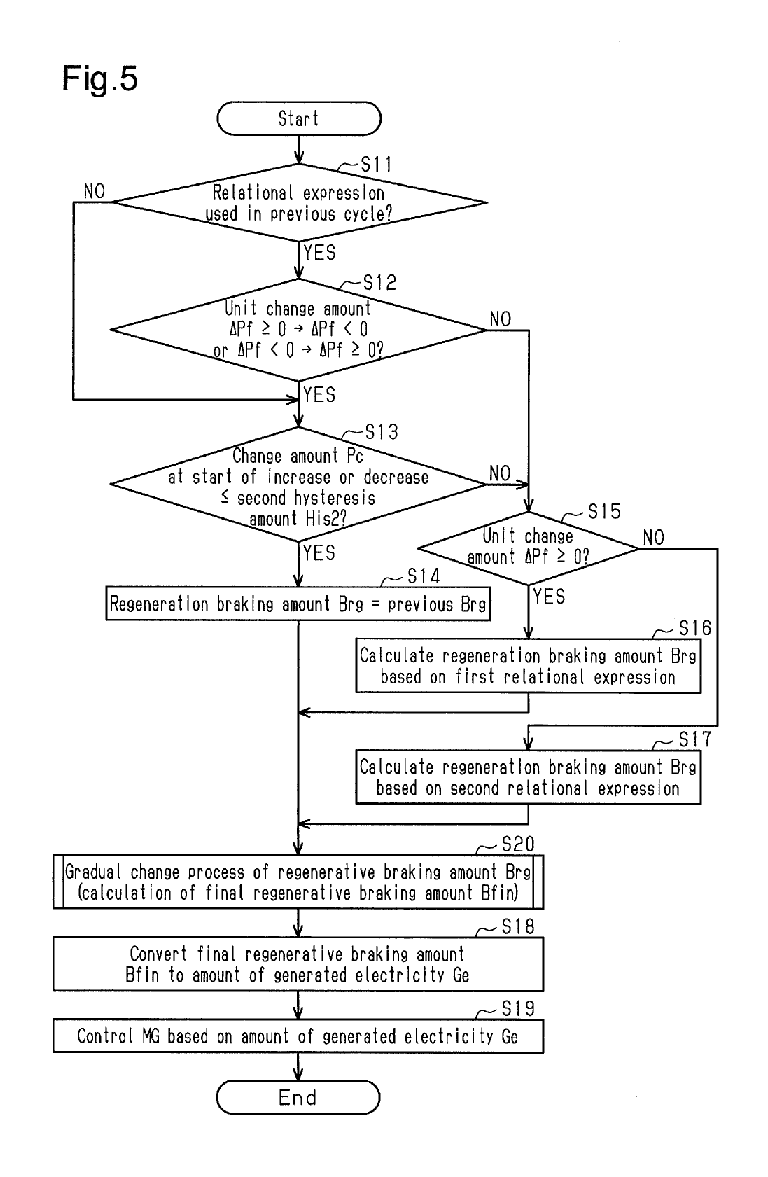

As shown in FIG. 5, when the regenerative control process is started, the electronic control unit 40 executes the process of Step S11. In Step S11, the electronic control unit 40 determines whether the regenerative braking amount Brg is calculated based on the first relational expression or the second relational expression in the previous regenerative control process of the regenerative control process repeated for every control cycle. In the initial regenerative control process immediately after the main switch of the vehicle has been switched on, the previous regenerative braking amount Brg is set to the initial value (zero) of the regenerative braking amount Brgset to. Then, the initial value of the regenerative braking amount Brg is not calculated by using the first relational expression or the second relational expression. Therefore, in the initial regenerative control process, the regenerative braking amount Brg is determined not to have been calculated by using the first relational expression or the second relational expression. In a case in which the determination is affirmative in Step S11 (YES in Step S11), the processing by the electronic control unit 40 moves to Step S12. Further, in a case in which the determination is negative in Step S11 (NO in Step S11), the processing by the electronic control unit 40 moves to Step S13.

In Step S12, the electronic control unit 40 subtracts the brake hydraulic pressure Pf that is one pressure before from the current (latest) brake hydraulic pressure Pf of the brake hydraulic pressure Pf detected by the brake hydraulic pressure sensor 47, thereby calculating a unit change amount ΔPf of the brake hydraulic pressure Pf. Then, the electronic control unit 40 determines whether the unit change amount ΔPf calculated in the previous regenerative control process as greater than or equal to zero becomes less than zero by the current regenerative control process. The electronic control unit 40 also determines whether the unit change amount ΔPf of less than zero that has been calculated in the previous regenerative control process is greater than or equal to zero by the current regenerative control process. When one of these two determinations, is affirmative (YES in Step S12), the processing by the electronic control unit 40 moves to Step S13.

In Step S13, the electronic control unit 40 calculates, as a change amount Pc, the absolute value of the difference between the brake hydraulic pressure Pf, which starts to vary, and the current brake hydraulic pressure Pf. In other words, the electronic control unit 40 calculates, as a change amount Pc, the absolute value of the difference between the brake hydraulic pressure Pf, which is determined to be affirmative by two determinations in Step S12, and the current brake hydraulic pressure Pf. Then, the electronic control unit 40 determines whether the calculated change amount Pc is smaller than or equal to the second hysteresis amount His2. In a case in which the change amount Pc is determined to be smaller than or equal to the second hysteresis amount His2 (YES in Step S13), the processing by the electronic control unit 40 moves to Step S14.

In Step S14, the electronic control unit 40 sets the regenerative braking amount Brg in the current regenerative control process to a value that is equal to the regenerative braking amount Brg of the previous regenerative control process. In Step S14, in calculating the regenerative braking amount Brg, neither the first relational expression nor the second relational expression is used. Therefore, in Step S11, which is the next regenerative control process, the regenerative braking amount Brg is determined not to have been calculated by using the first relational expression or the second relational expression (NO in Step S11).

In contrast, when both the two determinations are negative (NO in Step S12) in Step S12, the processing by the electronic control unit 40 moves to Step S15. Further, in Step S13, in a case in which the change amount Pc is determined to be greater than the second hysteresis amount His2 (NO in Step S13), the processing by the electronic control unit 40 also moves to Step S15.

In Step S15, the electronic control unit 40 determines whether the unit change amount ΔPf is greater than or equal to zero. In a case in which the unit change amount ΔPf is determined to be greater than or equal to zero (YES in Step S15), the processing by the electronic control unit 40 moves to Step S16.

In Step S16, the electronic control unit 40 calculates the regenerative braking amount Brg by using the first relational expression based on the current vehicle speed SP and the brake hydraulic pressure Pf. In a case in which the regenerative braking amount Brg is calculated in Step S16, the regenerative braking amount Brg is determined to have been calculated by using the first relational expression or the second relational expression (NO in Step S11) in Step S11, which is the next regenerative control process.

In contrast, in Step S15, in a case in which the unit change amount ΔPf is determined to be less than zero (NO in Step S15), the processing by the electronic control unit 40 moves to Step S17. In Step S17, the electronic control unit 40 calculates the regenerative braking amount Brg by using the second relational expression based on the current vehicle speed SP and the brake hydraulic pressure Pf. In a case in which the regenerative braking amount Brg is calculated in Step S17, the regenerative braking amount Brg is determined to have been calculated by using the first relational expression or the second relational expression (NO in Step S11) in Step S11, which is the next regenerative control processing.

When the regenerative braking amount Brg is calculated in Step S14, Step S16 or Step S17, the processing by the electronic control unit 40 moves to Step S20. In Step S20, gradual change process for gradually reducing the calculated regenerative braking amount Brg with the lapse of time is performed whenever necessary, thereby calculating a braking amount after the process as the final regenerative braking amount Bfin. The gradual change process will be described in detail below. When the gradual change process is ended, the processing by the electronic control unit 40 moves to Step S18.

In Step S18, the final regenerative braking amount Bfin is converted to an amount of generated electricity Ge. That is, the amount of generated electricity Ge necessary for the motor generator 20 to exert the final regenerative braking amount Bfin is calculated. Conversion of the final regenerative braking amount Bfin to the amount of generated electricity Ge is calculated by a predetermined relational expression, and the like, and the greater the final regenerative braking amount Bfin, the greater the amount of generated electricity Ge becomes. After calculation of the amount of generated electricity Ge, the processing by the electronic control unit 40 moves to Step S19.

In Step S19, the electronic control unit 40 generates an operation signal MSmg so that the motor generator 20 can function as a generator at the amount of generated electricity Ge and outputs the operation signal MSmg to the motor generator 20. Thereafter, one cycle of the regenerative control process is completed to attain a predetermined control cycle and, then, a next cycle of the regenerative control process is started again.

Next, a more detailed description will be given of the gradual change process (Step S20) executed during the regenerative control process.

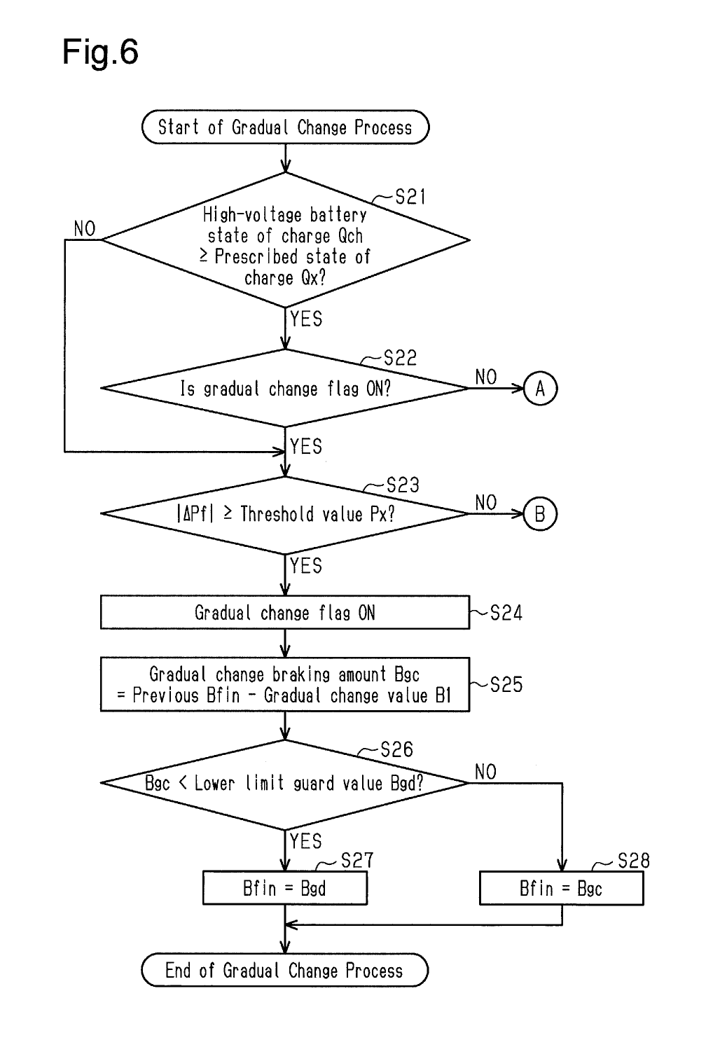

As shown in FIG. 6, in Step S14, Step S16, or Step S17, when the regenerative braking amount Brg is calculated to disclose the gradual change process, the electronic control unit 40 executes Step S21 in the gradual change process. In Step S21, the electronic control unit 40 determines whether the current state of charge Qch of the high-voltage battery 22 is higher than or equal to a prescribed state of charge Qx. In general, the state of charge Qch of the high-voltage battery 22 of the hybrid system is controlled so as to be in a predetermined regular use range (for example, 40 to 70%). The above-described prescribed state of charge Qx is set so that the state of charge Qch of the high-voltage battery 22 is higher than the vicinity of the upper limit value of the regular use range or the upper limit value of the regular use range. In a case in which the state of charge Qch is lower than the prescribed state of charge Qx (NO in Step S21), the processing by the electronic control unit 40 moves to Step S23. In a case in which the state of charge Qch is lower than the prescribed state of charge Qx (NO in Step S21), the processing by the electronic control unit 40 moves to Step S22.

In Step S22, the electronic control unit 40 determines whether the gradual change flag is ON at the time of executing Step S22. The gradual change flag indicates whether the process for gradually reducing the regenerative braking amount Brg was performed in the gradual change process of the previous regenerative control process. When the gradual change flag is ON, it indicates that the process for reducing the regenerative braking amount Brg was performed, and when the gradual change flag is OFF, it indicates that the process for reducing the regenerative braking amount Brg was not performed. In a case in which the gradual change flag is determined to be ON (YES in Step S22), the processing by the electronic control unit 40 moves to Step S23.

In Step S23, the electronic control unit 40 determines whether the absolute value of the unit change amount ΔPf of the brake hydraulic pressure Pf is less than or equal to a predetermined threshold value Px. The threshold value Px is a value for determining whether the depression amount of the brake pedal 32 will not undergo any change and whether the brake hydraulic pressure Pf is kept substantially constant, and it is set to zero or a significantly small value. In a case in which the absolute value of the unit change amount ΔPf is determined to be less than or equal to the threshold value Px (YES in Step S23), the processing by the electronic control unit 40 moves to Step S24.

In Step S24, the electronic control unit 40 turns the gradual change flag to ON. The electronic control unit 40 also keeps the gradual change flag to be ON, in a case in which the gradual change flag is already kept ON. Thereafter, the processing by the electronic control unit 40 moves to Step S25.

In Step S25, the electronic control unit 40 calculates a gradual change braking amount Bgc by subtracting a predetermined gradual change value B1 from the final regenerative braking amount Bfin calculated in the previous regenerative control process (gradual change process). The gradual change value B1 is set to be such a small value that will not be perceived by the driver at the moment when the braking amount applied to the vehicle is decreased by the gradual change value B1. After calculation of the gradual change braking amount Bgc, the processing by the electronic control unit 40 moves to Step S26.

In Step S26, the electronic control unit 40 determines whether the gradual change braking amount Bgc calculated in Step S25 is less than a predetermined lower limit guard value Bgd. The lower limit guard value Bgd is used to control the final regenerative braking amount Bfin such that it does not become smaller than or equal to the lower limit guard value Bgd. In this embodiment, the lower limit guard value Bgd is a negative value. In a case in which the final regenerative braking amount Bfin has a negative value, the motor generator 20 generates electricity at a negative amount of generated electricity. That is, the motor generator 20 functions as a motor by utilizing the electricity of the high-voltage battery 22. In Step S26, in a case in which the gradual change braking amount Bgc is determined to be less than the lower limit guard value Bgd (YES in Step S25), the processing by the electronic control unit 40 moves to Step S27.

In Step S27, the electronic control unit 40 calculates the final regenerative braking amount Bfin as the lower limit guard value Bgd. Thereafter, the gradual change process by the electronic control unit 40 is ended, and the processing by the electronic control unit 40 moves to Step S18 in the regenerative control process. The subsequent processing is as described above.

In contrast, in Step S26, in a case in which the gradual change braking amount Bgc is determined to be greater than or equal to the lower limit guard value Bgd (NO in Step S26), the processing by the electronic control unit 40 moves to Step S28. In Step S28, the electronic control unit 40 calculates the final regenerative braking amount Bfin as the gradual change braking amount Bgc. Thereafter, the gradual change process by the electronic control unit 40 is ended. The processing by the electronic control unit 40 moves to Step S18 in the regenerative control process. The processes from Step S25 to Step S28 correspond to the decreasing process, which decreases the final regenerative braking amount Bfin.

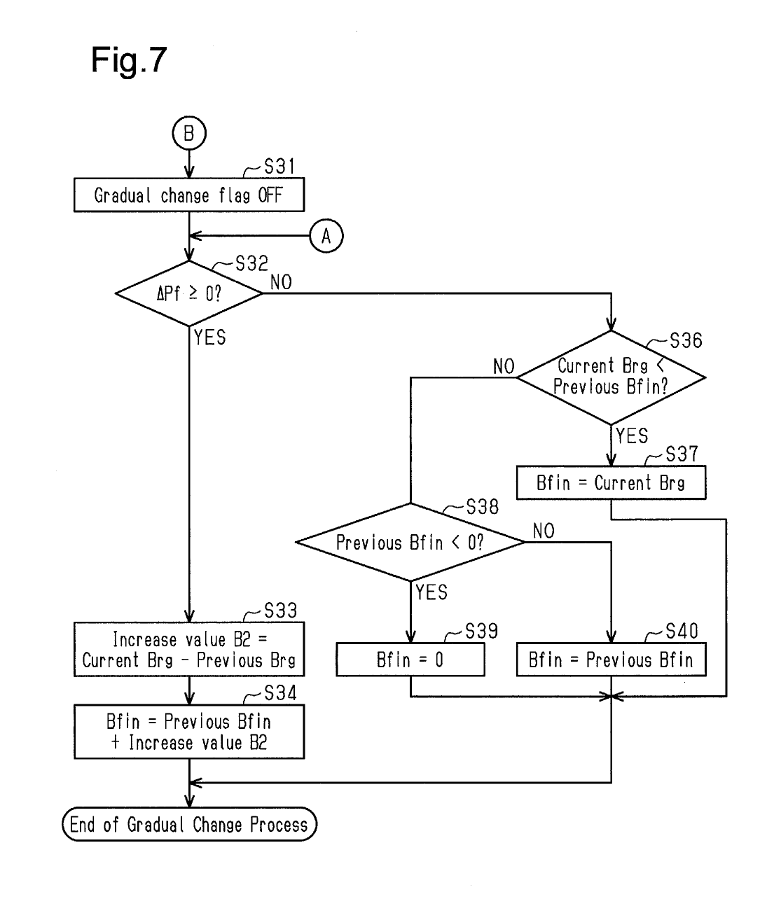

Now, in Step S23, which has been described above, in a case in which the absolute value of the unit change amount ΔPf of the brake hydraulic pressure Pf is determined to be greater than the threshold value Px (NO in Step S23), the processing by the electronic control unit 40 moves to Step S31 shown in FIG. 7. In Step S31, the electronic control unit 40 turns the gradual change flag to OFF. The electronic control unit 40 also keeps the gradual change flag OFF in a case in which the gradual change flag has been already in an OFF state. Thereafter, the processing by the electronic control unit 40 moves to Step S32. Further, in Step S22 shown in FIG. 6, even in a case in which the gradual change flag is determined not to be ON, that is, the gradual change flag is determined to be OFF (NO in Step S22), the processing by the electronic control unit 40 moves to Step S32.

In Step S32, the electronic control unit 40 determines whether the unit change amount ΔPf of the brake hydraulic pressure Pf is greater than or equal to zero. In a case in which the unit change amount ΔPf is greater than or equal to zero (YES in Step S32), the processing by the electronic control unit 40 moves to Step S33.

In Step S33, the electronic control unit 40 calculates an increase value B2 by subtracting the regenerative braking amount Brg calculated in the previous regenerative control process from the regenerative braking amount Brg calculated in the current regenerative control process. After calculation of the increase value B2, the processing by the electronic control unit 40 moves to Step S34.

In Step S34, the electronic control unit 40 calculates, as the final regenerative braking amount Bfin, a value obtained by adding the increase value B2 to the final regenerative braking amount Bfin calculated in the previous regenerative control process. Thereafter, the gradual change process by the electronic control unit 40 is ended, and the processing by the electronic control unit 40 moves to Step S18 in the regenerative control process.

In Step S32, in a case in which the unit change amount ΔPf of the brake hydraulic pressure Pf is determined to be less than zero (NO in Step S32), the processing by the electronic control unit 40 moves to Step S36. In Step S36, the electronic control unit 40 determines whether the regenerative braking amount Brg calculated in the current regenerative control process is smaller than the final regenerative braking amount Bfin calculated in the previous regenerative control process. In a case in which the current regenerative braking amount Brg is smaller than the previous final regenerative braking amount Bfin, the processing by the electronic control unit 40 moves to Step S37.

In Step S37, the electronic control unit 40 calculates the regenerative braking amount Brg calculated in the current regenerative control process as a final regenerative braking amount Bfin. Thereafter, the gradual change process by the electronic control unit 40 is ended, and the processing by the electronic control unit 40 moves to Step S18 of the regenerative control process.

In contrast, in Step S36, in a case in which the current regenerative braking amount Brg is determined to be greater than or equal to the previous final regenerative braking amount Bfin, the processing by the electronic control unit 40 moves to Step S38. In Step S38, the electronic control unit 40 determines whether the final regenerative braking amount Bfin calculated in the previous regenerative control process has a negative value (less than zero). In a case in which the previous final regenerative braking amount Bfin is determined to be a negative value (YES in Step S38), the processing by the electronic control unit 40 moves to Step S39.

In Step S39, the electronic control unit 40 calculates the final regenerative braking amount Bfin as zero. Thereafter, the gradual change process by the electronic control unit 40 is ended, and the processing by the electronic control unit 40 moves to Step S18 in the regenerative control process.

In contrast, in a case in which the previous final regenerative braking amount Bfin is determined to be greater than or equal to zero (NO in Step S38) in Step S38, the processing by the electronic control unit 40 moves to Step S40. In Step S40, the electronic control unit 40 calculates the final regenerative braking amount Bfin in the previous regenerative control process as a final regenerative braking amount Bfin. Thereafter, the gradual change process by the electronic control unit 40 is ended, and the processing by the electronic control unit 40 moves to Step S18 in the regenerative control process.

Next, with reference to FIG. 4, a description will be given of operations and advantages of the processes performed in Step S11 to Step S17, of the above-described regenerative control process. In the following description, the vehicle speed SP is not changed but is constant.

When the brake pedal 32 is depressed and the brake hydraulic pressure Pf is increased from a state in which the brake pedal 32 is not depressed, as indicated by a solid line in FIG. 4, first, the regenerative braking amount Brg of the motor generator 20 starts to increase. At this time, the regenerative braking amount Brg is calculated by using the first relational expression (corresponding to Step S12, Step S15 and Step S16 in FIG. 5). Further, as indicated by a solid line in FIG. 4, after the regenerative braking amount Brg of the motor generator 20, a hydraulic braking amount Bf of the hydraulic brake 31 also starts to increase.

It is now assumed that the brake hydraulic pressure Pf is changed from increase to decrease at the time when the brake hydraulic pressure Pf has reached the hydraulic pressure P2. At this time, as indicated by an arrow in FIG. 4, the hydraulic braking amount Bf of the hydraulic brake 31 is constant until it reaches a hydraulic pressure P3 lower than the hydraulic pressure P2 by in first hysteresis amount His1. Thereafter, as indicated by a broken line in FIG. 4, the hydraulic braking amount Bf decreases with a decrease in brake hydraulic pressure Pf.

In contrast, if the brake hydraulic pressure Pf is changed from increase to decrease at the time when the brake hydraulic pressure Pf has reached the hydraulic pressure P2, as indicated by an arrow in FIG. 4, the regenerative braking amount Brg of the motor generator 20 is constant until it reaches a hydraulic pressure P4 lower than the hydraulic pressure P2 by the second hysteresis amount His2 (corresponding to Step S12 to Step S14 in FIG. 5). Then, after the brake hydraulic pressure Pf has reached the hydraulic pressure P4, as indicated by a broken line in FIG. 4, the regenerative braking amount Brg also decreases with a decrease in brake hydraulic pressure Pf. The regenerative braking amount Brg at this time is calculated by using the second relational expression (corresponding to Step S12, Step S15 and Step S17 in FIG. 5).

Since the second hysteresis amount His2 is greater than the first hysteresis amount His1, the hydraulic pressure P4 is lower than the hydraulic pressure P3. Consequently, for example, as compared with a case in which the regenerative braking amount Brg of the motor generator 20 is controlled so as to be decreased from the hydraulic pressure P3 in synchronization with the start of a decrease in the hydraulic braking amount Bf of the hydraulic brake 31, it is possible to lengthen a period of time during which the regenerative braking amount Brg of the motor generator 20 is not decreased. In other words, even after a decrease in the hydraulic braking amount Bf of the hydraulic brake 31, a period of time that corresponds to the difference between the first hysteresis amount His1 and the second hysteresis amount His2 can be set as a period of time during which the motor generator 20 is not decreased in amount of generated electricity. Consequently, even if the period of time during which the brake pedal 32 is depressed is short, it is possible to sufficiently secure an amount of generated electricity and an electricity generating period by the motor generator 20. As a result, the high-voltage battery 22 can be efficiently charged.

In the above-described example, until the brake hydraulic pressure Pf reaches the hydraulic pressure P4 although it is lower than the hydraulic pressure P3, the regenerative braking amount Brg is not decreased but kept constant. In contrast, if the brake hydraulic pressure Pf is lower than the hydraulic pressure P3, the hydraulic braking amount Bf is decreased. Therefore, the entire braking amount obtained by adding the regenerative braking amount Brg to the hydraulic braking amount Bf is decreased when the brake hydraulic pressure Pf is lower than the hydraulic pressure P3. Consequently, there is less likelihood of a feeling of uncomfortableness on the part of the driver of the vehicle that the entire braking amount is not decreased (the vehicle is not decelerated) despite the fact that the driver lowers the depression amount of the brake pedal 32.

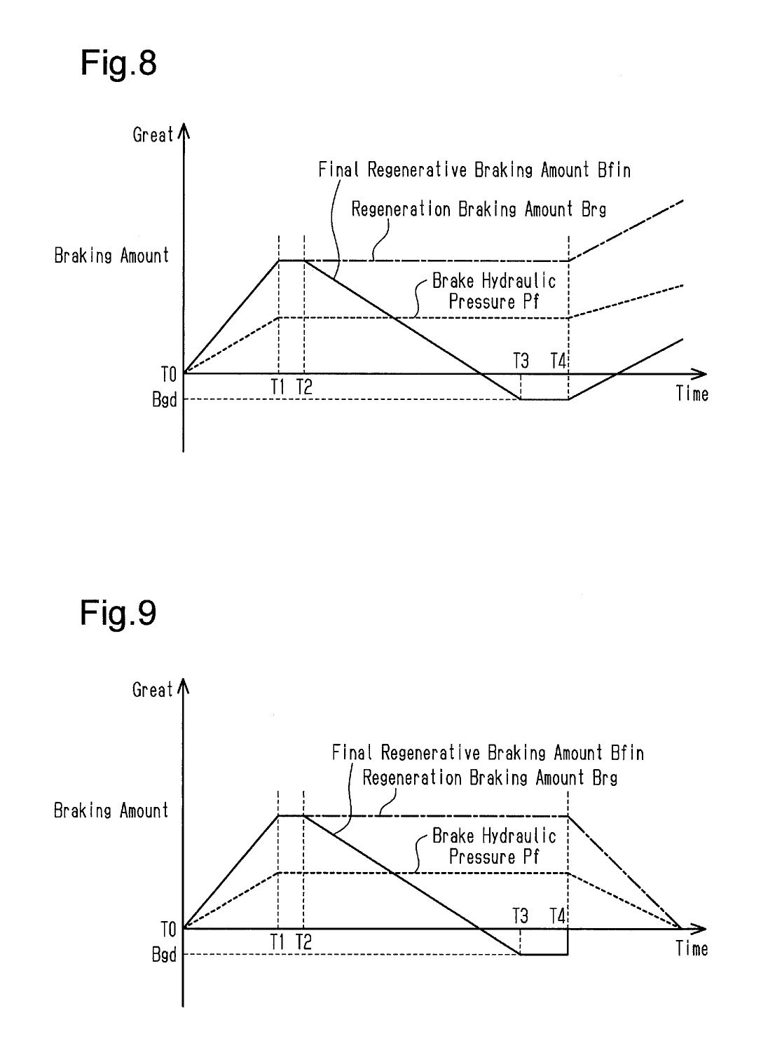

Next, a description will be given of operations and advantages of the gradual change process in the regenerative control process, with reference to FIGS. 8 and 9. In the following description, the vehicle speed SP is not changed but is assumed to be constant. Further, at a point in time T0 in FIGS. 8 and 9, the state of charge Qch of the high-voltage battery 22 is assumed to be less than the prescribed state of charge Qx. Still further, to make the description simple, the second hysteresis amount His2 of the regenerative braking amount Brg is assumed to be zero.

As shown in FIG. 8, at the point in time T0, when the brake pedal 32 is depressed to increase the brake hydraulic pressure Pf, the regenerative braking amount Brg indicated by an alternate long and short dashed line in FIG. 8 is accordingly increased. At this time, since the state of charge Qch of the high-voltage battery 22 is still less than the prescribed state of charge Qx, the regeneration of the brake in the motor generator 20 due to an excessively high value of the state of charge Qch of the high-voltage battery 22 is restricted. The final regenerative braking amount Bfin, therefore, coincides with the regenerative braking amount Brg (corresponding to Step S21, Step S31 to Step S33, Step S35 in FIGS. 6 and 7).

Then, in a case in which in a period of time from a point in time T1 to a point in time T4, the depression amount of the brake pedal 32 is constant and the brake hydraulic pressure Pf is substantially constant, the regenerative braking amount Brg is also constant. It is now assumed that, at a point in time T2, which is after the point in time T1 but before the point in time T4, the state of charge Qch of the high-voltage battery 22 is higher than or equal to the prescribed state of charge Qx. If, during the period from the point in time T2 to the point in time T4, the motor generator 20 executes the regenerative braking at the regenerative braking amount Brg and electricity is accordingly supplied to the high-voltage battery 22, there is a possibility that the state of charge Qch of the high-voltage battery 22 may greatly exceed the prescribed state of charge Qx. The above situation will result in deterioration of the high-voltage battery 22. Further, in a case in which the depression amount of the brake pedal 32 is increased again to increase the brake hydraulic pressure Pf, no electricity can be further supplied to the high-voltage battery 22. Thus, the motor generator 20 may be unable to execute the regenerative braking.

In contrast, in the above-described embodiment, in a period of time from the point in time T2 to the point in time T4, the final regenerative braking amount Bfin is decreased by a gradual change value B1 for every predetermined control cycle with the lapse of time (corresponding to Step S21 to Step S27 in FIG. 6). Consequently, as compared with a case in which the motor generator 20 executes the regenerative braking at the regenerative braking amount Brg, the state of charge Qch of the high-voltage battery 22 is prevented from greatly exceeding the prescribed state of charge Qx. As a result, it is possible to suppress problems such as the above-described deterioration of the high-voltage battery 22 and an inability of the motor generator 20 to execute the regenerative braking from occurring. From the point in time T2 to the point in time T4, the final regenerative braking amount Bfin is decreased in a stepwise manner. However, it is depicted briefly by using a straight line in FIG. 8.

Further, in a period of time from the point in time T2 to the point in time T4, the final regenerative braking amount Bfin is decreased regardless of a substantially constant depression amount of the brake pedal 32. However, an amount of decrease per unit time is small. The final regenerative braking amount Bfin is also constant in deceleration. Consequently, even if the final regenerative braking amount Bfin is decreased, the driver of the vehicle is less likely to perceive the reduction in braking amount.

Although the final regenerative braking amount Bfin is gradually decreased in a period of time from the point in time T2 to the point in time T4, the final regenerative braking amount Bfin has a positive value for a certain period of time from the point in time T2. Consequently, if a period of time during which the brake hydraulic pressure Pf is kept constant is long and a period of time during which the final regenerative braking amount Bfin has a positive value is also long, the state of charge Qch of the high-voltage battery 22 may greatly exceed the prescribed state of charge Qx.

In the above-described embodiment, as shown in FIG. 8, the final regenerative braking amount Bfin may be a negative value. That is, in a case in which a period of time from the point in time T2 to the point in time T4 is long, during the latter part of the period of time, the motor generator 20 functions as a motor to decrease the state of charge Qch of the high-voltage battery 22. Consequently, even if the state of charge Qch of the high-voltage battery 22 greatly exceeds the prescribed state of charge Qx temporarily, the state of charge Qch is, thereafter, decreased and comes close to the prescribed state of charge Qx.

In the above-described embodiment, a negative lower limit guard value Bgd is set for the final regenerative braking amount Bfin. Therefore, when the final regenerative braking amount Bfin reaches the lower limit guard value Bgd at a point in time T3, which is after the point in time T2 but before the point in time T4, the final regenerative braking amount Bfin will not be further decreased. Consequently, there is no chance that the final regenerative braking amount Bfin will become a significantly small value (a significantly great negative value) (corresponding to Step S26 and Step S28 in FIG. 6). As a result, there is less likelihood of a situation in which the state of charge Qch of the high-voltage battery 22 greatly exceeds the prescribed state of charge Qx temporarily and thereafter, excessively large electricity is consumed, instead, resulting in a decrease in the state of charge Qch of the high-voltage battery 22.

Then, as shown in FIG. 8, when the depression amount of the brake pedal 32 is increased to increase the brake hydraulic pressure Pf at the point in time T4, the final regenerative braking amount Bfin is also increased. In the above-described embodiment, even if a period of time from the point in time T2 to the point in time T4 is long, the state of charge Qch of the high-voltage battery 22 will not greatly exceed the prescribed state of charge Qx. In other words, with regard to the state of charge Qch of the high-voltage battery 22, there is still room in which the motor generator 20 executes the regenerative braking to charge the high-voltage battery 22. Therefore, when the brake hydraulic pressure Pf is increased to increase the final regenerative braking amount Bfin at the point in time T4, there is less likelihood of a situation in which the high-voltage battery 22 is fully charged and the motor generator 20 is unable to execute the regenerative braking. That is, when the brake hydraulic pressure Pf is changed to an increase from being substantially constant, the motor generator 20 is able to reliably generate the final regenerative braking amount Bfin.

Further, in the above-described embodiment, when the brake hydraulic pressure Pf is increased at the point in time T4, the final regenerative braking amount Bfin is increased by the crease value B2 at a time. Then, the increase value B2 is calculated by subtracting the previous regenerative braking amount Brg from the current regenerative braking amount Brg. That is, the increase rate of the final regenerative braking amount Bfin when the brake hydraulic pressure Pf is changed to an increase from being substantially constant is equal to the increase rate of the regenerative braking amount Brg and it is in accordance with an increase in the brake hydraulic pressure Pf. Therefore, regardless of whether such processing (decreasing process) is executed that the above-described final regenerative braking amount Bfin is decreased by the gradual change value B1 at a time, it is possible to obtain a change in deceleration that is similar to an increase in the amount of brake hydraulic pressure Pf. It is possible to suppress a feeling of uncomfortableness on the part of the driver of the vehicle that the response of the brake pedal 32 differs depending on the presence or absence of execution of the decreasing process.

In contrast, as shown in FIG. 9, in a case in which the final regenerative braking amount Bfin has a negative value immediately before the point in time T4, with a decrease in the brake hydraulic pressure Pf due to a decrease in the depression amount of the brake pedal 32 at the point in time T4, the final regenerative braking amount Bfin will be zero (corresponding to Step S38 and Step S39 in FIG. 7). Consequently, in such a situation in which the depression amount of the brake pedal 32 is estimated to be decreased to decrease the electricity that is charged to the high-voltage battery 22, it is possible to prevent the high-voltage battery 22 from being decreased in the state of charge Qch due to the final regenerative braking amount Bfin that is set to be a negative value.

Even if the final regenerative braking amount Bfin becomes zero, the hydraulic brake 31 will generate a hydraulic braking amount Bf corresponding to the brake hydraulic pressure Pf. Consequently, even if the final regenerative braking amount Bfin becomes zero as described in the above example, a braking amount corresponding to the hydraulic pressure Pf in terms of the entire braking amount is obtained. Therefore, it is possible to reduce possibility that a feeling of uncomfortableness on the part of the driver of the vehicle that the vehicle does not decelerate regardless of depression of the brake pedal 32.

Further, in a period of time from the point in time T2 to the point in time T4, if the final regenerative braking amount Bfin has a positive value, the depression amount of the brake pedal 32 may be decreased to decrease the brake hydraulic pressure Pf. In this case, if the final regenerative braking amount Bfin is allowed to be in agreement with the regenerative braking amount Brg, the final regenerative braking amount Bfin will be increased. Consequently, depending on the case, such a situation can be developed that the entire braking amount is increased, regardless of a decrease in the depression amount of the brake pedal 32.

In this respect, in the above-described embodiment, until the regenerative braking amount Brg is in agreement with the final regenerative braking amount Bfin, the final regenerative braking amount Bfin is kept at the previous final regenerative braking amount Bfin (corresponding to Step S38 and Step S40 in FIG. 7). Then, since the hydraulic braking amount Bf of the hydraulic brake 31 is decreased depending on the brake hydraulic pressure Pf, the entire braking amount is decreased. Therefore, the entire braking amount is also decreased in accordance with a decrease in the depression amount of the brake pedal 32. Thus, the driver of the vehicle is free from unnecessary confusion.

The present embodiment may be modified as follows. The above-described embodiments and the following modifications can be combined as long as the combined modifications remain technically consistent with each other.

The manner in which the motor generator 20 is drivably coupled to the engine 10 is not limited to the above-described embodiment. Further, in addition to the first pulley 12, the transfer belt 13, and the second pulley 14, a deceleration mechanism configured by a plurality of gears, and the like, or a clutch for engaging and disengaging the driving-force transferring path, and the like, may be interposed between the engine 10 and the motor generator 20.

With regard to the high-voltage battery 22 and the low-voltage battery 24, any output voltage is acceptable. Further, the output voltage of the low-voltage battery 24 does not necessarily need to be lower than that of the high-voltage battery 22, and they may be equal in output voltage.

The types of the high-voltage battery 22 and the low-voltage battery 24 are not limited to those described in the above-described embodiment. As the high-voltage battery 22 and the low-voltage battery 24, in addition to a lithium-ion battery and a lead-acid battery, for example, a nickel metal hydride battery, a sodium-sulfur (NAS) battery and a solid-state battery may be employed.

A motor generator that mainly assists the traveling torque of the engine 10 and a motor generator that generates electricity mainly by torque from the engine 10 may be provided separately. In this case, the regenerative control process described in the above embodiment may be employed in the motor generator, which generates electricity by torque from the engine 10.

In place of the brake hydraulic pressure sensor 47, a brake stroke sensor for detecting the depression amount of the brake pedal 32 (operation amount of the brake pedal 32) may be employed as a brake sensor. In addition to the brake hydraulic pressure sensor 47, a brake stroke sensor may be also provided.

The first relational expression and the second relational expression in the above-described embodiment are not limited to those in which the regenerative braking amount Brg is determined as a function but may include those in which the regenerative braking amount Brg is expressed in terms of a map, and the like. That is, as long as the regenerative braking amount Brg can be obtained with reference to the vehicle speed SP and the brake hydraulic pressure Pf, any mode can be used as relational expressions.

The relationship between the regenerative braking amount Brg and the hydraulic braking amount Bf in the above-described embodiment is merely an example. It is acceptable that, as a whole, the higher the hydraulic braking amount Bf, the higher the regenerative braking amount Brg becomes. The relationship between them does not necessarily need to be in a proportional relationship, for example.

The regenerative braking amount Brg may be varied not only by the vehicle speed SP and the brake hydraulic pressure Pf but also by other parameters. Other parameters include, for example, the inclination of the vehicle (uphill traveling or downhill traveling) and the temperature of the high-voltage battery 22.

Regardless of the state of charge Qch of the high-voltage battery 22, the decreasing process in which the final regenerative braking amount Bfin is gradually decreased (Step S25 to Step S28) may be performed. That is, in the gradual change process of the regenerative control process, the process of Step S21 may be omitted. Regardless of the state of charge Qch of the high-voltage battery 22, if a period of time during which the final regenerative braking amount Bfin has a positive value is long, there is a possibility that the state of charge Qch of the high-voltage battery 22 may be excessively high. It is therefore effective to apply the gradual change process of the above-described embodiment.

A gradual change value B1 of regenerative braking amount Brg may be a variable. For example, the gradual change value B1 may be made less with an increase in the difference between the regenerative braking amount Brg and the previous final regenerative braking amount Bfin. In this modified embodiment, immediately after the point in time T2 shown in FIG. 8, the final regenerative braking amount Bfin is decreased at a greater ratio and thereafter, it is gradually decreased at a lower ratio.

The lower limit guard value Bgd of the final regenerative braking amount Bfin does not necessarily need to be a negative value. That is, the lower limit guard value Bgd may be zero or a positive value. For example, in a case in which the prescribed state of charge Qx is relatively small in capacity, the state of charge Qch of the high-voltage battery 22 is less likely to become excessively high even if the lower limit guard value Bgd is zero or a positive value.

The process on the lower limit guard value Bgd may be omitted. That is, a decrease in the final regenerative braking amount Bfin does not necessarily need to be restricted, when the brake hydraulic pressure Pf is substantially constant and the final regenerative braking amount Bfin is decreased. For example, even if the gradual change value B1 is small and a period of time during which the brake hydraulic pressure Pf is substantially constant is long but unless the final regenerative braking amount Bfin is made excessively small, no problem will be posed by omitting the process on the lower limit guard value Bgd.

The process performed when the brake hydraulic pressure Pf is changed to an increase from being substantially constant is not limited to the example of the above-described embodiment. For example, the final regenerative braking amount Bfin may be gradually brought close to the regenerative braking amount Brg. In this case, the final regenerative braking amount Bfin is increased, at a time, by a value greater than the increase value B2 obtained by subtracting the previous regenerative braking amount Brg from the current regenerative braking amount Brg. Thereby, the final regenerative braking amount Bfin gradually comes close to the regenerative braking amount Brg.

Further, when the process on the increase value B2 is omitted and the brake hydraulic pressure Pf is changed to an increase from being substantially constant, the regenerative braking amount Brg may be calculated as the final regenerative braking amount Bfin. In this case, the final regenerative braking amount Bfin is abruptly changed into the regenerative braking amount Brg. Nevertheless, if the ratio of the regenerative braking amount Brg of the motor generator 20 in relation to the entire braking amount is low, the entire braking amount is changed at a small ratio, regardless of an abrupt change in final regenerative braking amount Bfin.

The process performed when the brake hydraulic pressure Pf is decreased from being substantially constant is not limited to the example of the above-described embodiment. There may be employed, for example, one of the previous final regenerative braking amount Bfin and the regenerative braking amount Brg that is closer to zero. Further, in a case in which the previous final regenerative braking amount Bfin has a negative value, in a period of time during which the brake hydraulic pressure Pf starts to decrease from being substantially constant, the final regenerative braking amount Bfin may be kept at a negative value thereof so that the high-voltage battery 22 can be charged.

It is possible to omit the gradual change process in its entirety in the above-described embodiment. In this case, the final regenerative braking amount Bfin is set to the regenerative braking amount Brg calculated in Step S14, Step S16 or Step S17.

In each of the above-described embodiments, the electronic control unit 40 is not limited to a device that includes a CPU and a ROM and executes software processing. For example, at least part of the processes executed by the software in the above-described embodiments may be executed by hardware circuits dedicated to executing these processes (such as ASIC). That is, the electronic control unit 40 may be modified as long as it has any one of the following configurations (a) to (c). (a) A configuration including a processor that executes all of the above-described processes according to programs and a program storage device such as a ROM that stores the programs. (b) A configuration including a processor and a program storage device that execute part of the above-described processes according to the programs and a dedicated hardware circuit that executes the remaining processes. (c) A configuration including a dedicated hardware circuit that executes all of the above-described processes. A plurality of software processing circuits each including a processor and a program storage device and a plurality of dedicated hardware circuits may be provided. That is, the above processes may be executed in any manner as long as the processes are executed by processing circuitry that includes at least one of a set of one or more software processing circuits and a set of one or more dedicated hardware circuits.

Therefore, the present examples and embodiments are to be considered as illustrative and not restrictive and the disclosure is not to be limited to the examples and embodiments given herein.

1. A regeneration controller that is employed in a hybrid system, wherein
the hybrid system including
an engine as a driving source of a vehicle,
a motor generator that is drivably coupled to the engine,
a battery that supplies electricity to the motor generator,
a hydraulic brake configured to decelerate the vehicle, and
a brake sensor that detects a depression amount of a brake pedal used to operate the hydraulic brake,
the regeneration controller is configured to control a regenerative braking amount of the motor generator,
the hydraulic brake is configured such that a hydraulic braking amount applied to the vehicle is decreased after the depression amount of the brake pedal is decreased by a predetermined first hysteresis amount from the start of a decrease in the depression amount,
the regeneration controller is configured to control the motor generator such that, when the depression amount of the brake pedal is decreased, the regenerative braking amount starts decreasing after the depression amount of the brake pedal is decreased by a second hysteresis amount from the start of a decrease in the depression amount, and
the second hysteresis amount is set to be greater than the first hysteresis amount.

2. The regeneration controller according to claim 1, wherein the regeneration controller is configured to execute a decreasing process to gradually decrease the regenerative braking amount of the motor generator with a lapse of time in a period of time during which an absolute value of a change amount of the depression amount of the brake pedal per unit time is less than or equal to a predetermined threshold value.

3. The regeneration controller according to claim 2, wherein the regeneration controller is configured to execute the decreasing process when conditions are met, one of the conditions being that a state of charge of the battery is higher than or equal to a prescribed charging amount.

4. The regeneration controller according to claim 2, wherein, in the decreasing process, after the regenerative braking amount becomes a predetermined lower limit guard value, the regenerative braking amount is set to the lower limit guard value regardless of a lapse of time.

5. The regeneration controller according to claim 4, wherein
the lower limit guard value is a negative value, and
the regeneration controller is configured to cause the motor generator to function as a motor that utilizes electricity of the battery in a case in which the regenerative braking amount has a negative value.

6. The regeneration controller according to claim 2, wherein the regeneration controller is configured to stop the decreasing process and increase the regenerative braking amount in accordance with an increase in the depression amount of the brake pedal in a case in which the depression amount of the brake pedal is increased to exceed the threshold value during the decreasing process.
